(19) United States
(12) Patent Application Publication
(10) Pub. No.: US 2017/0059118 A1
(43) Pub. Date: Mar. 2, 2017

(54) LUMINAIRE ASSEMBLY WITH SUSPENSION POINT OVER CENTER OF MASS THAT IS NOT VERTICALLY IN-LINE WITH MAJOR AXIS OF SHADE

(71) Applicant: Matthew Kennedy, Chilliwack (CA)

(72) Inventor: Matthew Kennedy, Chilliwack (CA)

(73) Assignee: LOOM INC., Chilliwack, BC (CA)

(21) Appl. No.: 15/119,771

(22) PCT Filed: Feb. 12, 2015
(86) PCT No.: PCT/CA2015/050105

§ 371 Date: Aug. 18, 2016

(30) Foreign Application Priority Data
Feb. 20, 2014 (CA) 2843099

(51) Int. Cl. F21V 1/14; F21V 21/008

(52) U.S. Cl. CPC F21V 1/143; F21V 21/008; G02B 6/0081

(57) ABSTRACT

A luminaire which includes a body having a substantially vertical axis. A suspension support frame is secured asymmetrically to the body. The suspension support frame has a suspension portion that is vertically in-line with a center of mass of the luminaire and offset from the axis of the body.

This application is a National Stage completion of PCT/CA2015/050105 filed Feb. 12, 2015, Which claims priority from Canadian patent application serial no. 2,843,099 filed Feb. 20, 2014.

### FIELD

There is described herein a configuration of luminaire assembly with a suspension point over center of mass that is not vertically in-line with a major axis of the shade.

### BACKGROUND

Suspended lamp shades are typically suspended with a cable that is in-line with the major axis of the lamp shade. The major axis is defined as a theoretical line that passes vertically through the center of a cylinder or cone shaped lamp shade, or one that is equidistant from all corners of a square or rectangular or other geometrical fashioned lamp shade. Lamp shade frames typically have a mounting position in line with the major axis of the shade, which is also vertically in line with the center of mass of the assembly comprised of the shade and supporting frame as the masses of both the shade and the frame are equally balanced at the center of mass in line with the major axis of the shade.

In physics, the center of mass of a distribution of mass in space is the unique point where the weighted relative position of the distributed mass sums to zero. The distribution of mass is balanced around the center of mass and the average of the weighted position coordinates of the distributed mass defines its coordinates.

### SUMMARY

There is provided a luminaire which includes a body having a substantially vertical axis. A suspension support frame is secured asymmetrically to the body. The suspension support frame has a suspension portion that is vertically in-line with a center of mass of the luminaire and offset from the axis of the body.

This invention discloses a supporting frame that is mounted to only one side of a lamp shade, therefore the mass of the assembly is off center from the major axis of the lamp shade, closer to the more massive or weighted portion of the assembly. Since the center of mass, also referred to as the center of gravity, is not in line with the major axis of the shade, having a cable suspension point in the center of the shade at the major axis would cause a moment to occur between a fixed element of the suspension means and the center of mass, causing the shade to appear off kilter and improper as the shade is not held in a position where the major axis is vertical. The same effect may occur with pendant or rod suspension systems, though to a lesser extent. The invention is the assembly of a supporting frame and lamp shade with a center of mass that is biased to one side of the major axis of the lamp shade, and with a suspension point directly over the center of mass such that the lamp shade appears properly oriented and level with the major axis of the lamp shade nominally vertical in orientation.

The invention is a suspended luminaire assembly of a lamp shade and or light source module and a supporting frame or bracket that is mounted to only one side of the lamp shade or light source module, causing the assembly's center of mass to be off-center from the major axis of the shade or light source module, therefore the invention discloses a suspension point is above the center of mass to keep the shade level rather than in line with the major axis of the shade or light source module. Shade and light source module can be used interchangeably where a light source module comprised of an LED assembly or an OLED assembly whereby the emitting surface of an LED waveguide or an OLED panel resembles a light shade is deployed, in place of a traditional light bulb and shade.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective of the luminaire assembly comprising of a conical shade and a supporting frame revealing portions on the interior of a lamp shade, the major axis of the shade and the off-axis center of gravity of the assembly;

FIG. 2 is a top ohm view of the present invention, with a conical shade;

FIG. 3 is a side plan view of the present invention, with a conical shade;

FIG. 4 is a front plan view of the present invention, with a conical shade;

FIG. 5 is a perspective of the luminaire assembly comprising of a cylindrical shade and a supporting frame revealing portions on the interior of a lamp shade and a light bulb, the major axis of the shade and the off-axis center of gravity of the assembly;

FIG. 6 is a top plan view of the present invention, with a cylindrical shade and showing a light bulb;

FIG. 7 is a side plan view of the present invention, with a cylindrical shade;

FIG. 8 is a front plan view of the present invention, with a cylindrical shade;

### DETAILED DESCRIPTION

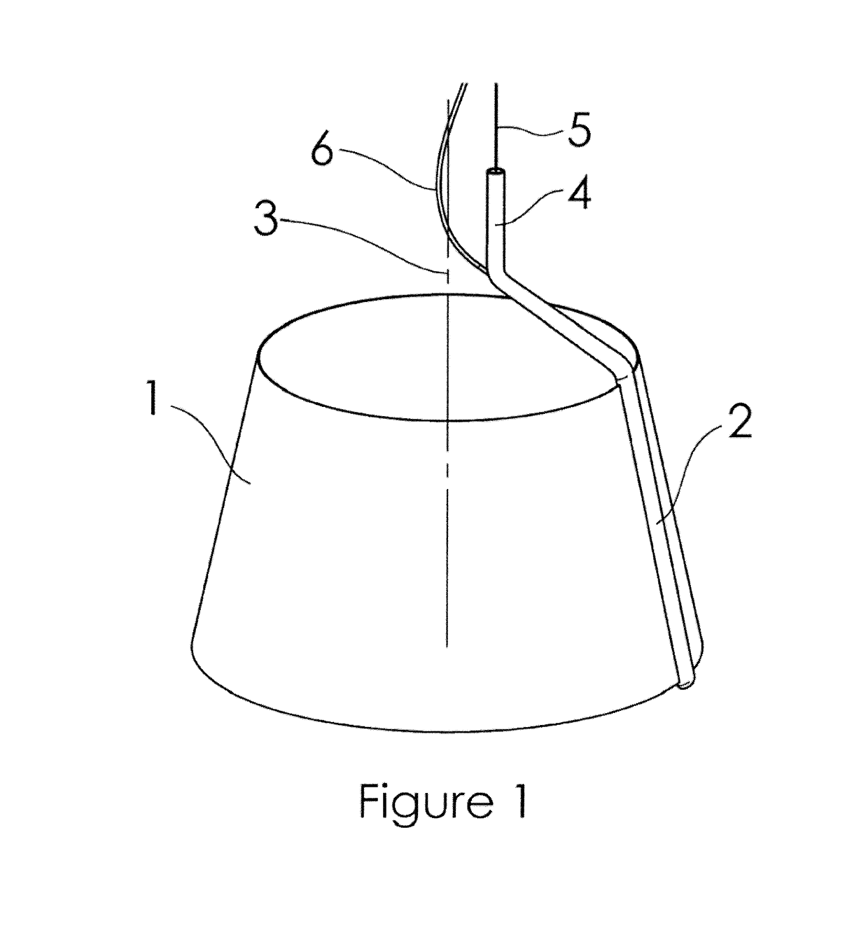

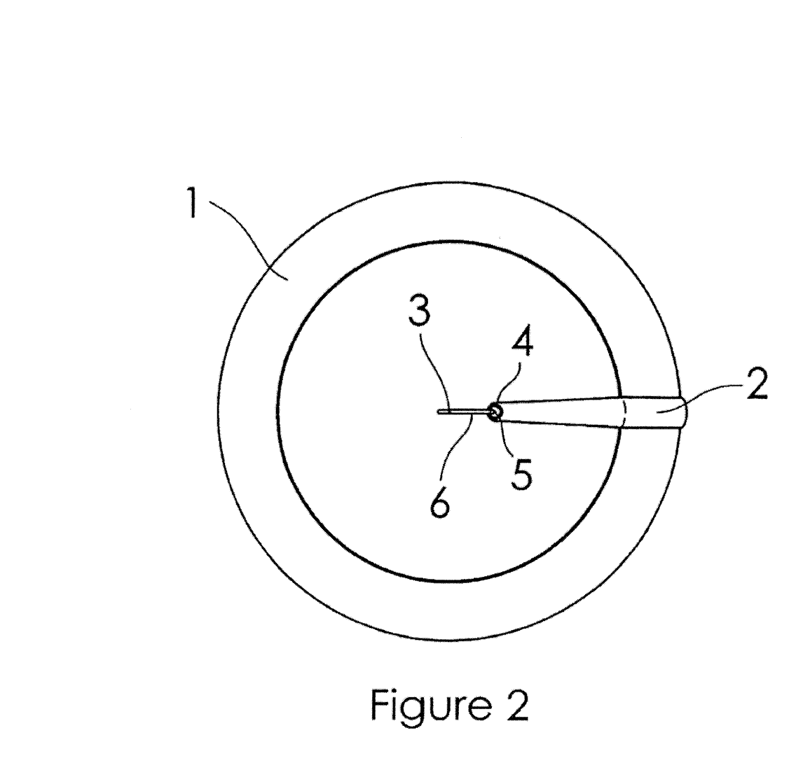

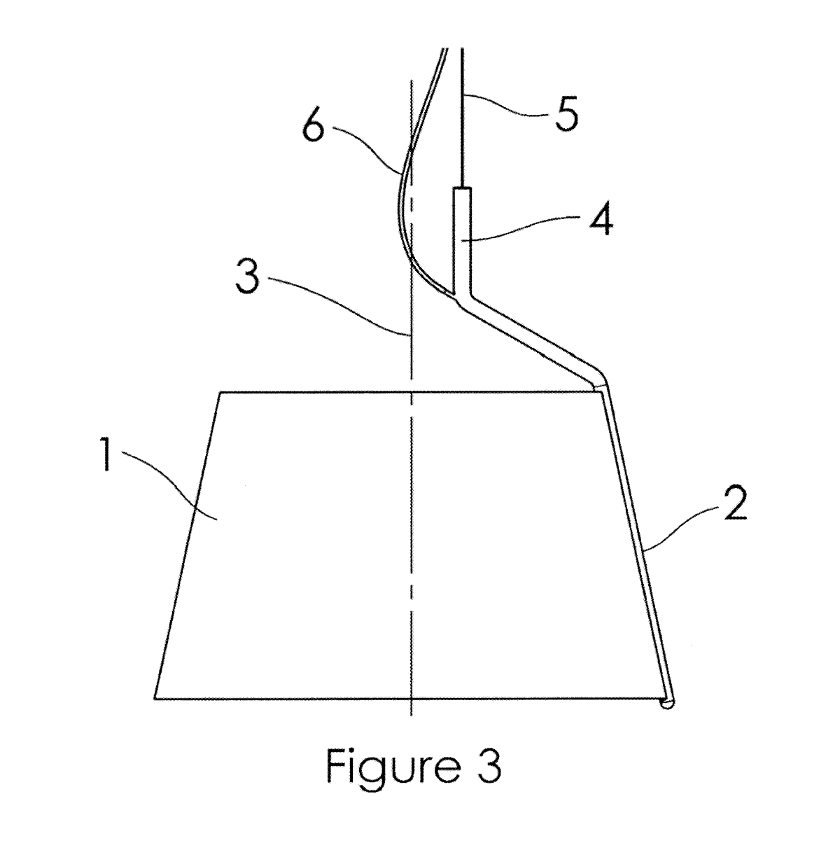

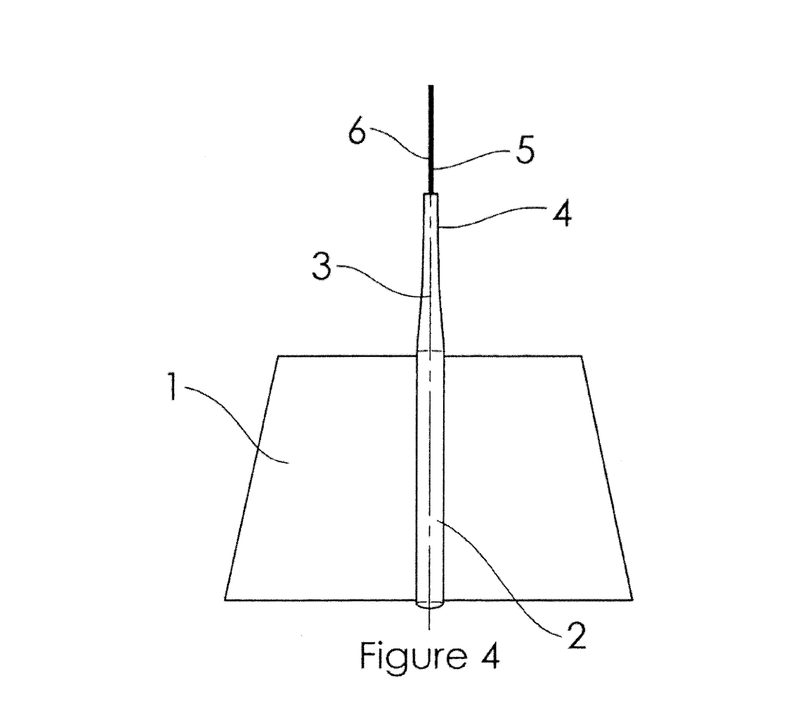

FIGS. 1 through 4 describe the preferred embodiment of the invention as a body 1 which consists of a light source using LED or OLED technology and having a nominally conical ‘lamp-shade’ shaped emitting surface supported on one side by a suspension support frame 2. Frame 2 is secured asymmetrically to shade 1, whereby the majority of the mass at one side of the assembly makes a position of the center of mass offset from and not in-line with the major axis 3 of the assembly as defined by the center axis 3 of the shade 1. As it is desirable to have a level looking lighting fixture, a supporting portion 4 of the frame 2 is in line with the center of mass of the assembly, keeping it level as suspension member 5, such as a cable or pendant or rod, is fixed thereto a suspension point at a suspension portion 4, through which cable 5 is routed or directly attached. A power source 6, in the form of a power cable may be employed independently of the suspension member 5, if so desired, and even though portions of said power source 6 are not in-line with said suspension portion 4 that is in-line with the center of mass of the lighting fixture assembly, said power source 6 either has little effect on the overall center of mass and therefore levelness of the assembly due to its proximity to center of mass and its own low mass, or it is compensated for in the design and placement of the suspension portion 4.

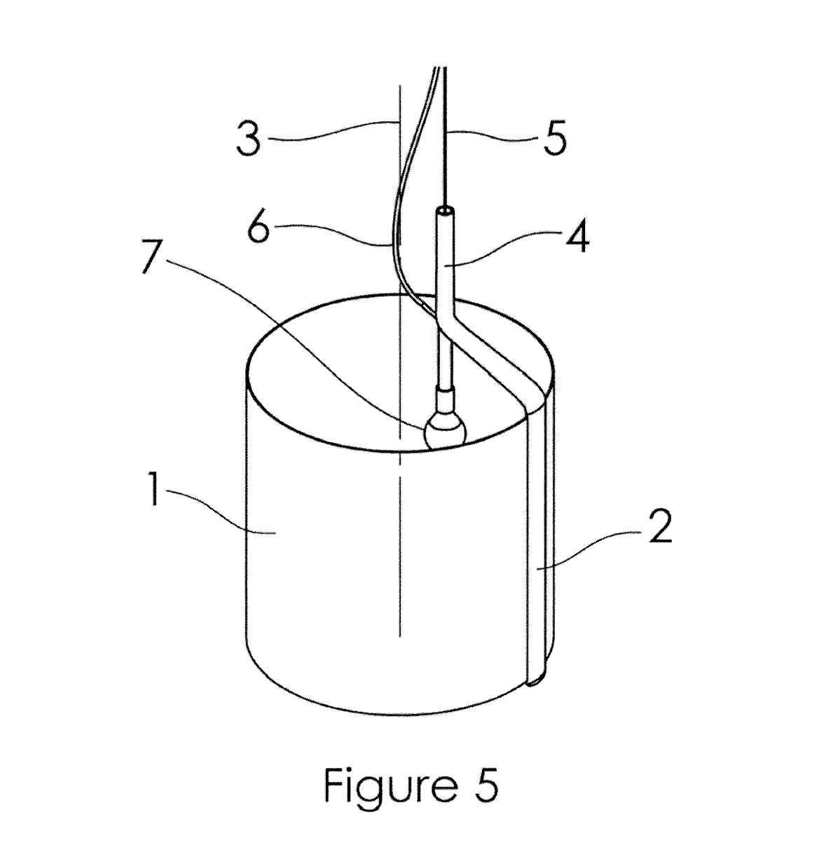

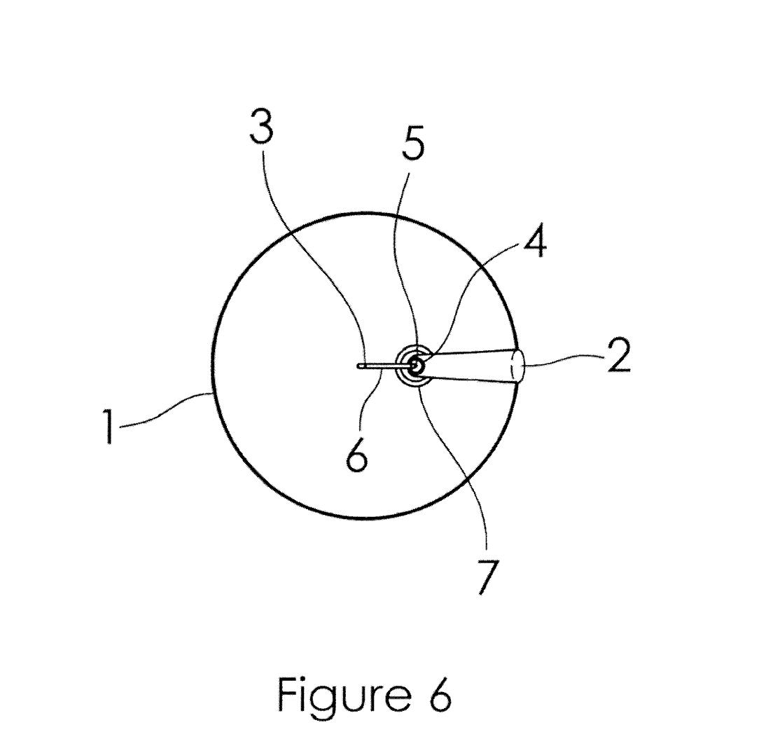

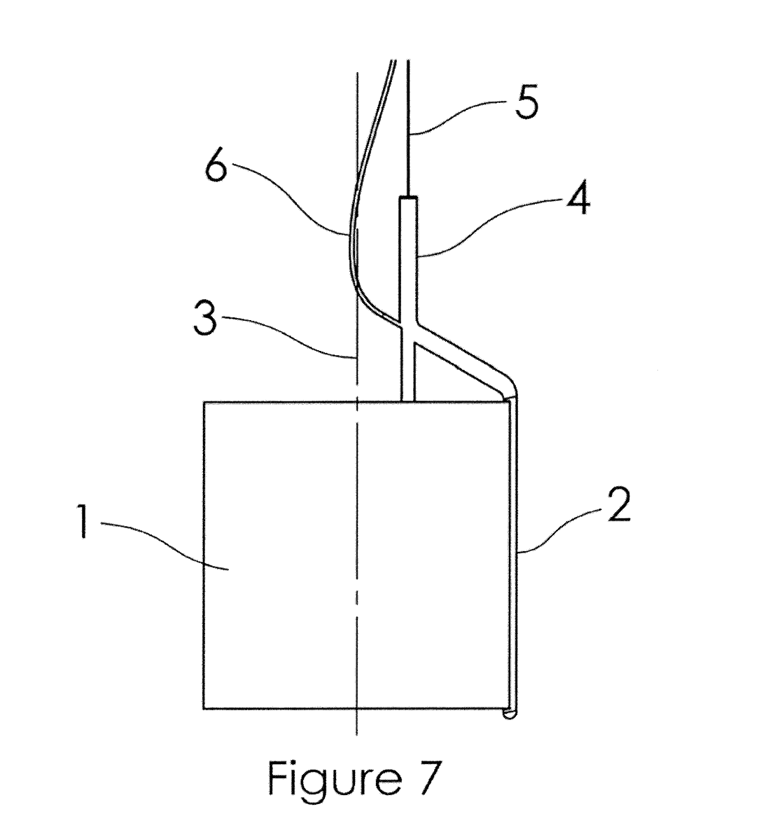

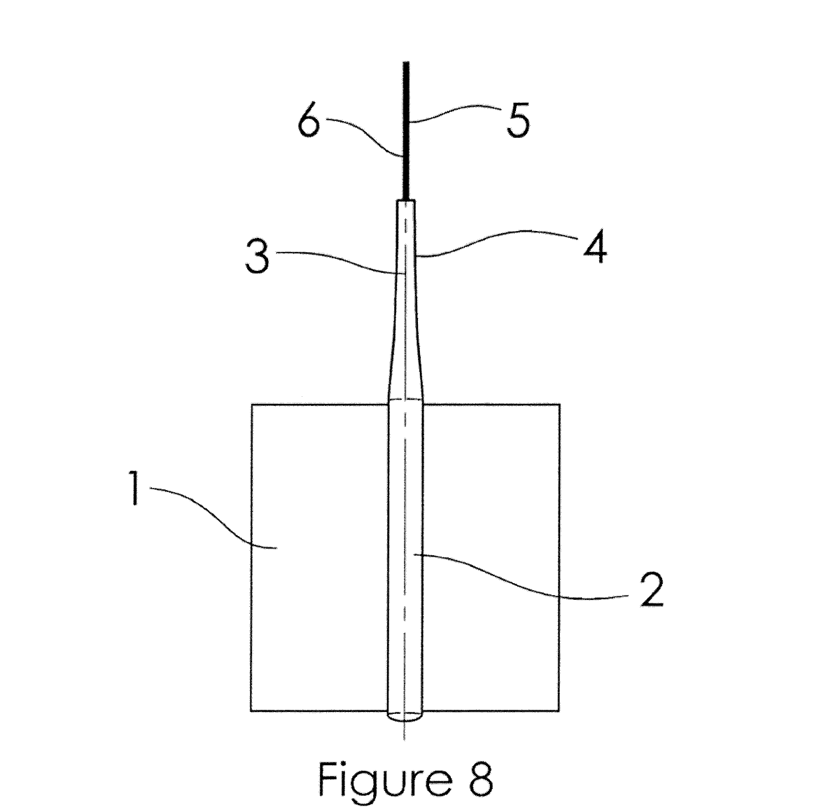

FIGS. 5 through 8 describe an alternative embodiment of the invention as a cylindrical lamp shade made of cloth or plastic or the like as typically employed in lamp shade construction, with a light source 7, such as a light bulb, suspended from the frame 2, the complete assembly including the light source 7 being balanced in respect to the center of mass by way of suspension portion 4 in-line with said center of mass.

The Luminaire assemblies described above each have a suspension point over center of mass that is not vertically in-line with major axis of shade. This provides a means to maintain level appearance of luminaire, with off-axis center of mass.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

1-9. (canceled)

10. A luminaire comprising:
a body (1) having a substantially vertical axis (3);
a suspension support frame (2) secured asymmetrically along one side of the body (1), the suspension support frame (2) having a suspension portion (4) projecting from the suspension support frame that is vertically in-line with a center of mass of the luminaire and offset from the axis (3) of the body (1);
the body (1) being suspended asymmetrically from the suspension portion (4) of the suspension support frame (2) by a single suspension member (5) with the axis (3) of the body (1) remaining vertical with the suspension member (5) maintaining the luminaire balanced at the center of mass.

11. The luminaire of claim 10, wherein the suspension member is a cable (5).

12. The luminaire of claim 10, wherein the suspension member (5) is separate and distinct from a power source (6).

13. The luminaire of claim 10, wherein the body (1) is nominally conical.

14. The luminaire of claim 10, wherein the body (1) is cylindrical.

15. The luminaire of claim 10, wherein the body (1) is a lamp shade.

16. The luminaire of claim 10, wherein the body (1) is a light source having a light emitting surface.

17. The luminaire of claim 10, wherein the body (1) is a light emitting OLED.

18. The luminaire of claim 10, wherein the body (1) is a light emitting waveguide.
